(19) United States
(12) Patent Application Publication
(10) Pub. No.: US 2004/0168181 A1
(43) Pub. Date: Aug. 26, 2004

(54) Extended capacity compact disc

(76) Inventor: Michael J. Stattelman, Ashland, VA (US)

Correspondence Address: Michael J. Stattelman, 219-D N. Cottage Green Dr., Ashland, VA, 23005, US

(21) Appl. No.: 10/772,896

(22) Filed: Feb. 5, 2004

Related U.S. Application Data
(60) Provisional application No. 60/446,398, filed on Feb. 11, 2003.

(51) Int. Cl. G11B 7/24

(52) U.S. Cl. 720/718

(57) ABSTRACT

The compact disc storage capacity is based on the surface area used in the placement of the data track, in light of this, the extended capacity compact disc is nothing more than an optical disc with increased surface area by adding folds, bends, creases or crimps to the various information storage materials used in the manufacturing process of all current models optical discs (polycarbonate plastic at present).

This patent application is based on Disclosure Document filed on 2 Oct. 2002 w/DD#520185, Along w/the Provisional Patent Application filed on 11 Feb. 2003

### BACKGROUND—FIELD OF INVENTION

This invention relates to Optical Discs and the like for the use of retaining various formats of information, with the focus being on those used in the entertainment avenues and commercial use of these products with computers, DVD players and CD players of all sorts.

### SUMMARY

The extended Capacity Compact Disc allows for more information in various formats to be placed on it, than current market Optical Discs in all current forms some examples being: CD, CDROM, Video Games, DVD and all of their various models to date.

### OBJECTS AND ADVANTAGES

The purpose of the Extended Capacity Compact Disc is to provide the user with increased information storage capacity, the various information formats include, DVD, Audio, MPEG, MP3, Movies, Video Games, WAV files, along with any number of computer program and media variations.

### BRIEF DESCRIPTION OF THE DRAWINGS

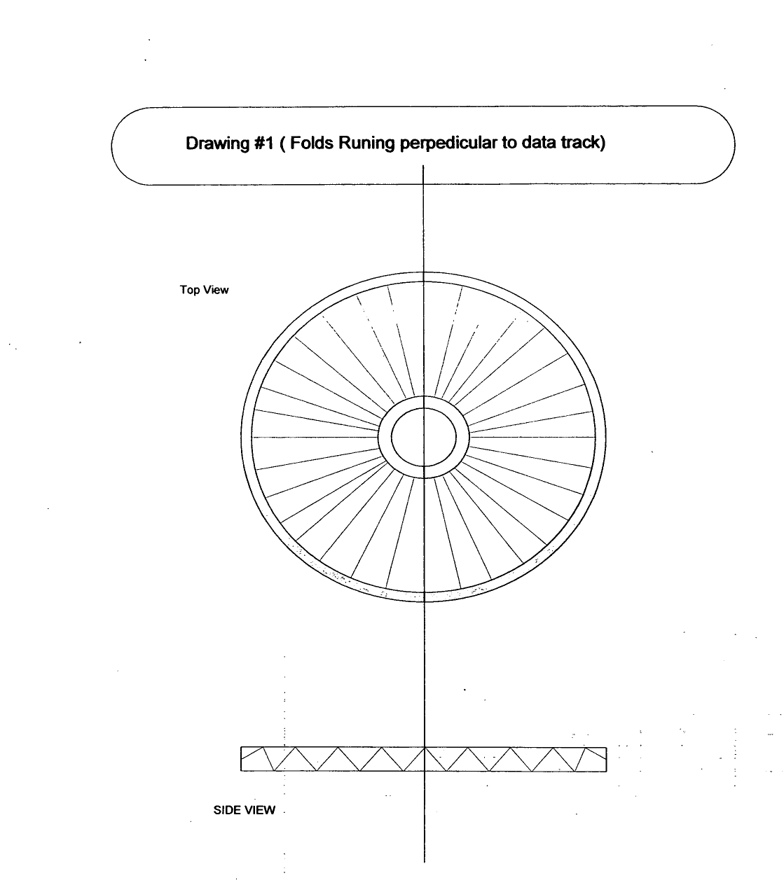

In FIG. 1: The information storage surface is shown with the folds that carry the information data track, running perpendicular to the data track itself. Visible in the side view.

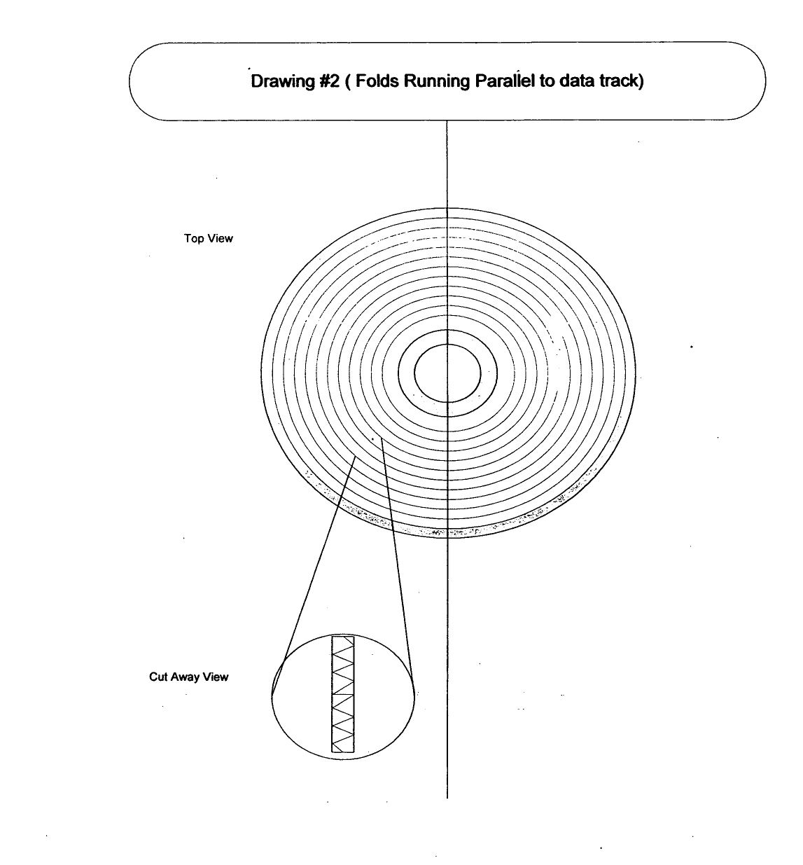

In FIG. 2: The information storage surface is shown with the folds that carry the information data track, running parallel to the data track itself. Visible in the Cut away view.

### PREFERRED EMBODIMENT—DESCRIPTION

Taken the basic Compact Disc (CD) or Digital Video Disc (DVD) increase the width to 1.8 millimeters (a 0.6 millimeter increase) or more, which would allow for the folding, crimping or creasing of the information (polycarbonate plastic) storage surface therefore expanding the available surface area of the disc and thus increasing the storage capacity of such disc. Precaution does however have to be taken into account with regards to the size of the width increase in order for the disc to function properly with current readers, burners and computers on the market today. It does help to know that the depth of the folds is that which determines the extended storage capacity, i.e. the deeper the fold or crease the more surface are and furthermore more storage capacity.

### Preferred Embodiment—Operation

The Extended Capacity Compact Disc works in the same manner as any CD,DVD or Optical Disc in use today with the laser eye of the reading device following and reading the data or information track with the exact same playback and quality sequences with the only difference being that of the folds or crimps allowing for more information to be placed on the disc that the ones currently on the market. Quality nor reading accuracy would be jeopardized due to the tracking system and motor used in most readers keeping the rate consistent.

### Conclusions, Ramifications, and Scope

Accordingly, it can be seen that the Extended capacity compact disc provides a wide variety of users the ability to place and use at a minimum 100% more information on it than the current market models to date, This will allow for smaller packaging requirements with regards to commercial and private information alike to use less materials than is at present needed. In other words a CD that can hold more songs, a DVD that holds complete movies or any extras the studio wants to place on it. Computer program discs that hold even more information so the need for more than one disc to hold a given program will be greatly reduced. Thus the scope of the invention should be determined by the appended claims and their legal equivalents, rather than by examples given.

What is claimed is:

1. That the adaptation of the folds, creases, bends, crimps or any manipulation to the information storage surface will increase the amount of information in various formats, that will be allowed on the disc itself and is unlike any other on the market to date with regards only to that of the folds, bends, creases or crimps to increase the surface area on the disc of either one or two sided, single as well as double layered optical discs:
